(19) United States
(12) Patent Application Publication
(10) Pub. No.: US 2015/0069151 A1
(43) Pub. Date: Mar. 12, 2015

(54) Fluid Injection Valve

(71) Applicant: Continental Automotive GmbH, Hannover (DE)

(72) Inventors: Stefano Filippi, Castel' Anselmo Collesalvetti (IT); Mauro Grandi, Livorno (IT); Francesco Lenzi, Livorno (IT); Valerio Polidori, Livorno (IT); Marco Bartoli, Livorno (IT)

(21) Appl. No.: 14/480,891

(22) Filed: Sep. 9, 2014

(30) Foreign Application Priority Data
Sep. 9, 2013 (EP) 13183481

(51) Int. Cl. F02M 61/10

(52) U.S. Cl. CPC F02M 61/10
USPC 239/584

(57) ABSTRACT

A fluid injection valve includes a fluid inlet tube with a recess and a valve body including a central longitudinal axis. The valve body includes a cavity with a fluid outlet portion. The injection valve also includes a valve needle received in the recess and in the cavity. The valve needle is axially displaceable with respect to the fluid inlet tube and the valve body for preventing a fluid flow through the fluid outlet portion in a closing position and releasing the fluid flow through the fluid outlet portion in other positions. The injection valve includes a spring element arranged in the recess and operable to interact with the valve needle for biasing the valve needle in axial direction towards its closing position, wherein the spring element is configured such that a spring stiffness of the spring element depends on a pressure of fluid in the recess.

### CROSS-REFERENCE TO RELATED APPLICATIONS

This application claims priority to EP Patent Application No. 13183481 filed Sep. 9, 2013. The contents of which are incorporated herein by reference in their entirety.

### TECHNICAL FIELD

The present disclosure relates to a fluid injection valve.

### BACKGROUND

Injection valves are in widespread use, in particular for internal combustion engines, where they may be arranged in order to dose the fluid into an intake manifold of the internal combustion engine or directly into the combustion chamber of a cylinder of the internal combustion engine.

Injection valves are manufactured in various forms in order to satisfy the differing needs for various types of combustion engines. Therefore, for example, their length, their diameter and all the various elements of the injection valve being responsible for the way the fluid is dosed may vary in a wide range. In addition to that, injection valves may accommodate an actuator for actuating a needle of the injection valve, which may, for example, be an electromagnetic actuator or piezoelectric actuator.

### SUMMARY

One embodiment provides a fluid injection valve, comprising a fluid inlet tube with a recess, a valve body having a central longitudinal axis and a cavity with a fluid outlet portion, a valve needle received in the recess of the fluid inlet tube and in the cavity of the valve body, the valve needle being axially displaceable with respect to the fluid inlet tube and the valve body between a closing position that prevents a fluid flow through the fluid outlet portion and other positions that allow the fluid flow through the fluid outlet portion, and a spring element arranged in the recess and arranged to interact with the valve needle to bias the valve needle in an axial direction towards the closing position, wherein a spring stiffness of the spring element depends on a pressure of fluid in the recess.

In a further embodiment, the valve needle comprises a spring rest, and the spring element is arranged between the valve body and the spring rest of the valve needle.

In a further embodiment, the spring element comprises an elastically deformable material, and the spring stiffness of the spring element depends on a pressure of fluid in the recess as a function of the elastically deformable material interacting with the fluid.

In a further embodiment, the spring element comprises a coil spring with a defined number of spring turns, and the elastically deformable material is arranged along at least part of an axial extension of the coil spring between the respective spring turns.

In a further embodiment, the spring element comprises an elastic ring-shaped tube.

In a further embodiment, the tube is hollow and has an interior that is sealed with respect to the recess.

In a further embodiment, the interior is filled with a gas or another fluid.

In a further embodiment, the valve is configured to open in a flow direction of the fluid at the fluid outlet portion and the spring element biases the valve needle in a longitudinal direction opposite to said flow direction.

Other embodiments provides an internal combustion engine, comprising a plurality of the fluid injection valves disclosed above.

### BRIEF DESCRIPTION OF THE DRAWINGS

Example embodiments of the fluid injection valve are explained below with reference to the figures, in which:

FIG. 1 shows a fluid injection valve with a valve assembly according to a first exemplary embodiment in a longitudinal section view,

FIG. 2a shows a force diagrams explaining the forces acting on a spring element of the fluid injection valve according to FIG. 1,

FIG. 2b shows a schematic longitudinal section view of the spring element of the fluid injection valve according to FIG. 1,

FIG. 3 shows a fluid injection valve with a valve assembly according to a second exemplary embodiment in a longitudinal section view,

FIG. 4a shows the spring element of the fluid injection valve according to FIG. 3 in a longitudinal section view,

FIG. 4b shows a schematic longitudinal section view of the spring element of the fluid injection valve according to FIG. 3,

FIG. 5a shows the load distributions of a valve needle in a conventional fluid injection valve, and

FIG. 5b shows the load distribution of a fluid injection valve according to the present disclosure.

### DETAILED DESCRIPTION

Embodiments of the invention to specify an injection valve which can be manufactured in a simple way and which facilitates a reliable and precise functioning.

A fluid injection valve is specified. It comprises a fluid inlet tube with a recess and a valve body including a central longitudinal axis. The valve body comprises a cavity with a fluid outlet portion. The recess in particular has a fluid inlet portion at an axial end opposite to the fluid outlet portion of the cavity. The fluid inlet tube and the valve body are preferably positionally fixed with respect to each other. The recess and the cavity are hydraulically connected. Expediently, the fluid injection valve may be configured such that fluid can flow from the fluid inlet portion of the recess through the recess into the cavity and further to the fluid outlet portion of the cavity. The fluid injection valve is in particular configured for dispensing fluid from the fluid outlet portion. Furthermore, the injection valve comprises a valve needle.

The valve needle is received in the recess of the fluid inlet tube and in the cavity of the valve body. Preferably, a first axial end of the valve needle is arranged in the recess of the fluid inlet tube and the valve needle extends from said end into the cavity of the valve body, and in particular through the fluid outlet portion to a second axial end of the valve needle. The second axial end in particular projects longitudinally beyond the cavity, preferably it projects longitudinally beyond the valve body.

In this case, the fluid injection valve is in particular an outward opening valve. In other words, the fluid injection valve is in particular configured to open in a flow direction of the fluid at the fluid outlet portion.

The valve needle is axially displaceable with respect to the fluid inlet tube and the valve body for preventing a fluid flow through the fluid outlet portion in a closing position and releases the fluid flow through the fluid outlet portion in other positions. In case of an outward opening valve, the valve needle is in particular axially moved away from the closing position in the above mentioned flow direction at the fluid outlet portion for opening the valve.

The injection valve comprises a spring element. The spring element is arranged in the recess and operable to mechanically interact with the valve needle for biasing the valve needle towards the closing position. In particular, the spring element is operable to act on the valve needle to move the valve needle in axial direction in its closing position and/or to keep the valve needle in its closing position. In case of an outward opening valve, the spring element is in particular operable to bias the valve needle in a longitudinal direction opposite to the above mentioned flow direction.

The spring element is configured such that a spring stiffness of the spring element depends on a pressure of fluid in the recess. Expediently, the spring element may be configured such that its spring stiffness increases with increasing fluid pressure and decreases with decreasing fluid pressure.

More specifically, the fluid injection valve may be configured to be supplied with pressurized fluid through the fluid inlet portion—for example from a fuel rail to which the fluid injection valve may be connected—so that the recess is filled with the pressurized fluid during operation of the fluid injection valve. The spring element may be configured to interact with the pressurized fluid in the recess in such fashion that its spring stiffness varies with the pressure of the pressurized fluid in the recess.

For example, the spring element may comprise an elastically deformable material for interacting with the pressurized fluid. In particular, the spring element may be configured in such fashion that the fluid interacts with the elastically deformable material to vary the shape and/or the elastic modulus of the latter in dependence of the pressure.

By means of the fluid injection valve according to the present disclosure, it is possible to control a needle load regardless of the fuel pressure to always guarantee the closing function and a tip sealing function. The spring stiffness being fuel pressure dependent allows a more reliable closing of the injector and helps avoiding uncontrolled valve needle opening if the fuel pressure increases. Thus, the fluid injection valve has a particularly low risk of unintended opening at high fluid pressures.

The subject fluid injection valve also makes it possible to operate the injection valve without additional or with a smaller amount of energy at fluid pressures which are lower than the maximum fluid pressure for which the fluid injection valve is specified. In conventional injection valves, a constant spring force of a spring element would have to be specified at the maximum fluid pressure to be sufficient to counter the hydraulic force tending to move the valve needle away from the closing position. When the hydraulic force is lower at low fluid pressures, the actuator unit would have to additionally supply the force difference to open the valve against the constant spring force in such a conventional injection valve.

As a result of this, actuator unit dimensions can be kept small in the fluid injection valve according to the present disclosure and, therefore, a minimum controllable fuel quantity can be reduced since the actuator becomes faster. The fact that the actuator unit becomes faster also facilitates performing multiple injections with minimized dwell time between consecutive injections, therefore supporting stratified combustion charge. Overall injection valve dimensions can be limited. Hydraulically balancing elements, like e. g. bellows or a dry actuator are made redundant.

In an advantageous embodiment, the valve needle comprises a spring rest and the spring element is arranged between the valve body and the spring rest of the valve needle. This allows a reliable and exact arrangement of the spring element.

In a further advantageous embodiment, the spring element comprises a coil spring with a given number of spring turns, wherein, along at least part of the axial extension of the coil spring between the respective spring turns, the elastically deformable material is arranged. By means of this, a desired dependency of the spring stiffness on the fuel pressure—in particular an increasing stiffness with increasing fuel pressure—can easily be achieved.

In a further advantageous embodiment, the spring element comprises an elastic ring-shaped tube. This allows an easy and cost-effective assembly of the injection valve.

The tube is in particular hollow and has an interior which is sealed with respect to the recess. The interior may be filled with a gas, such as air, or with a further fluid. The gas or the further fluid in the interior of the tube preferably has a pressure which is different—in particular lower—than the pressure of the pressurized fluid in the recess.

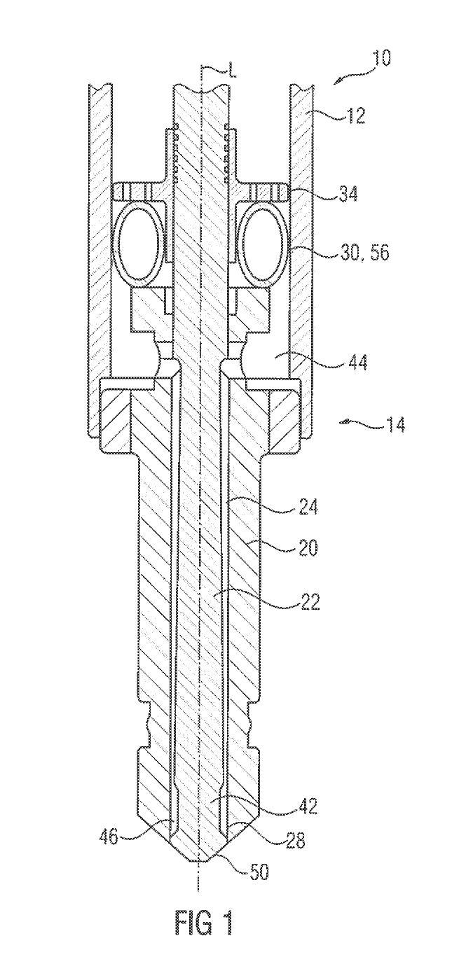

FIG. 1 shows an injection valve 10 which is suitable for dosing fluids, i.e. a fluid injection valve, and which comprises a valve assembly 14 and an inlet tube 12 and an actuator unit (not shown here). The injection valve 10 of this embodiment or any other embodiment according to the present disclosure may in particular be suitable for dosing fuel to an internal combustion engine.

The valve assembly 14 comprises a valve body 20 with a central longitudinal axis L. A cavity 24 is arranged in the valve body 20. A valve needle 22, which is movable in the axial direction, is arranged in the cavity 24.

The fluid inlet tube 12 has a fluid inlet portion at one axial end and is fixed to the valve body 20 at its opposite axial end. The cavity 24 is hydraulically coupled to the recess 44 of the fluid inlet tube 12 and a fuel connector (not shown here). The fuel connector is designed to be connected to a high pressure fuel chamber of an internal combustion engine, in which the fuel is stored under high pressure. The high pressure chamber may, for example, be a fuel rail.

The injection valve 10 is of an outward opening type.

On one of the free ends of the cavity 24, a fluid outlet portion 28 is formed, which is closed or opened depending on the axial position of the valve needle 22. Outside the closing position of the valve needle 22, there is a gap between the valve body 20 and the valve needle 22 at an axial end of the injection valve 10 facing away from of the fluid inlet tube 12. The gap forms a valve nozzle.

Furthermore, the valve needle 22 has a lower needle portion 42. The lower needle portion 42 has a groove 46. The groove 46 has a basically annular shape. The groove 46 allows a fluid flow to the fluid outlet portion 28.

At an axial end of the lower needle portion 42 which faces away from the fluid inlet tube 12, the valve needle 22 has a tip portion 50. Preferably, the tip portion 50 may, for example be conical, frusto-conical or semispherical. The tip portion 50 cooperates with the valve body 20 to prevent or enable the fluid flow through the fluid outlet portion 28.

The fluid is led from fluid inlet portion of the fluid inlet tube 12 through the recess 44 and further through the cavity 24 to the lower needle portion 42 to be led on through the groove 46 to the fluid outlet portion 28 near the tip portion 50 of the valve needle 22. The valve needle 22 prevents a fluid flow through the fluid outlet portion 28 in the valve body 20 in a closing position of the valve needle 22.

The valve needle is axially displaceable away from the closing position in direction of the fluid flow and the fluid outlet portion 28, i.e. downwards in FIG. 1. The tip portion 50 which projects longitudinally beyond the valve body 20 is moved further away from the valve body 20 in downstream direction when the needle is displaced out of the closing position.

The valve assembly 14 is provided with an actuator unit (not shown here), which preferably is an electro-magnetic actuator. The actuator unit 16 may, however, also comprise another type of actuator which is known to a person skilled in the art for this purpose. Such other type of actuator may be, for example, a piezoelectric actuator.

The electro-magnetic actuator unit comprises a coil (not shown here), which is preferably arranged inside a housing (not shown here). Furthermore, the electro-magnetic actuator unit comprises an armature (not shown here). The armature is, for instance, mechanically coupled with the valve needle 22 and is axially movable along the central longitudinal axis L. The coil is arranged such as to interact with the armature. The coil is designed and arranged such as to move the armature into the direction of the fluid outlet portion 28.

The armature cooperates with the valve needle 22 such that at least part of the lift generated by the coil with respect to the armature 3 is transferred to the valve needle 22, thereby moving the valve needle 22 in its opening position.

A spring element 30 is arranged in the recess 44 provided in the fluid inlet tube 12. For instance, the valve needle 22 comprises a spring rest 34 and the spring element 30 is arranged between the valve body 20 and the spring rest 34 of the valve needle 22. For instance, the valve body 20 comprises a brace element for the spring element 30. The brace element may be formed integrally with the valve body 20. The valve body 20 and the spring rest 34 of the valve needle 22 support the spring element 30. The spring element 30 is arranged to act on the valve needle 22 such as to move the valve needle 22 in the axial direction into its closing position and to retain the valve needle 22 in its closing position against the hydraulic force of the fluid. The spring element 30 is configured such that a spring stiffness of the spring element 30 depends on a fluid pressure in the recess 44.

The spring element 30 may force the valve needle 22 in longitudinal upstream direction. When the actuator unit 16, in particular the coil, is de-energized, the spring 30 is operable to force the valve needle 22 to move in the upstream axial direction into its closing position. k

In the embodiment shown in FIG. 1, the spring element 30 comprises an elastic ring-shaped tube 56. Preferably, the ring-shaped tube 56 is a hollow tube. The interior of the tube is in particular sealed from the recess 44, i.e. hydraulically separated from the recess 44. It may, for example, be filled with a gas such as air or a further fluid which may be the same fluid as the fluid dispensed from the fluid injection valve 10 or another sort of fluid.

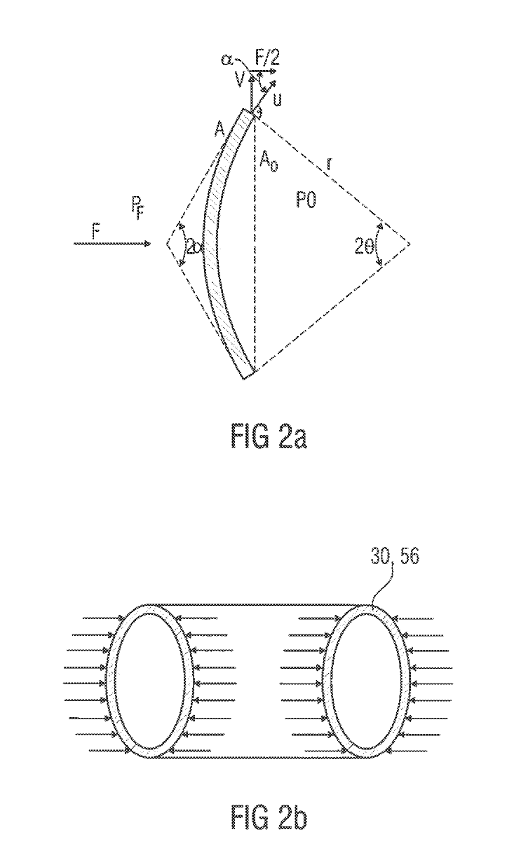

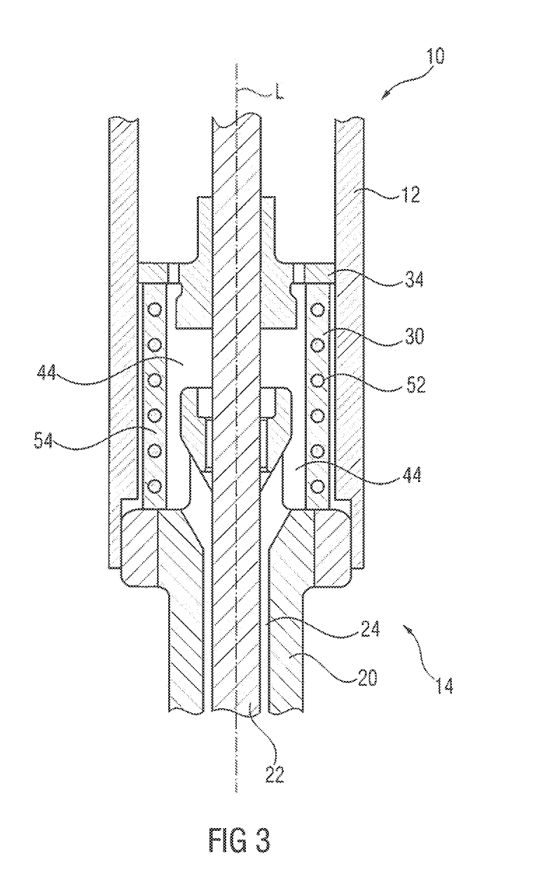

FIG. 2a shows an example of a force diagram explaining the change in spring stiffness depending on the fuel pressure of the fluid in the recess 44.

The fuel pressure p_{F} of the pressurized fluid in the recess 44 acts on the surface A of the ring-shaped tube 56 and generates a force F on the surface A. The force F effects a strain force U along a circumference of the ring-shaped tube 56. The strain force U can be split in its vector components. One of these components is a longitudinal axial force V.

A resulting spring stiffness can be calculated by means of the following equations:

A=r*θ eq. 1

Ao=r*sin θ eq. 2

Ao=(A/θ)*sin θ

F=(p_{F}−P0)/A eq. 3

U*cos α=F/2 eq. 4

V=U*sin α eq. 5

V=(F/2)*tan α

V=[[Ao*(p_{F}−P0)]*tan α]/2

K0=L/6 eq. 6

K=(L+V)/δ eq. 7

wherein p_{F} is the fuel pressure and P0 is the pressure of the gas or further fluid inside the ring-shaped tube 56, so that p_{F}−P0 represents the effective fuel pressure. Ao is the effective surface. K0 is the basic spring stiffness, representing the compression of the ring-shaped tube 56 by a distance δ when a load L is applied under the condition that p_{F} equals P0. K* is the resulting spring stiffness when p_{F} does not equal P0.

The longitudinal axial force V is the force component which supports the needle closing function. Consequently, an increase in fluid pressure p_{F} results in an increased longitudinal axial force V.

As can be seen from eq. 7, the resulting spring stiffness K* increases depending on the longitudinal axial force V.

FIG. 2b shows an example of the forces resulting from the effective fuel pressure p_{F}−P0 on the ring-shaped tube 56. The forces are roughly indicated by arrows in FIG. 2b.

FIG. 3 shows an injection valve 10 with another embodiment of the spring element 30. The spring element 30 comprises a coil spring with a given number of spring turns 52, wherein, along at least part of the axial extension of the coil spring between the respective spring turns 52, an elastically deformable material 54 is arranged. In FIG. 3, the elastically deformable material 54 is, for instance, arranged along the whole axial extension of the coil spring between the respective spring turns 52. The spring turns 52 are preferably completely embedded in the elastically deformable material 54, for example except from the upper and lower end surfaces which face upstream and downstream, respectively, in longitudinal direction. Spring turns 52 may be exposed at the upper and lower end surfaces. This may allow a particularly precise positioning of the spring element 30.

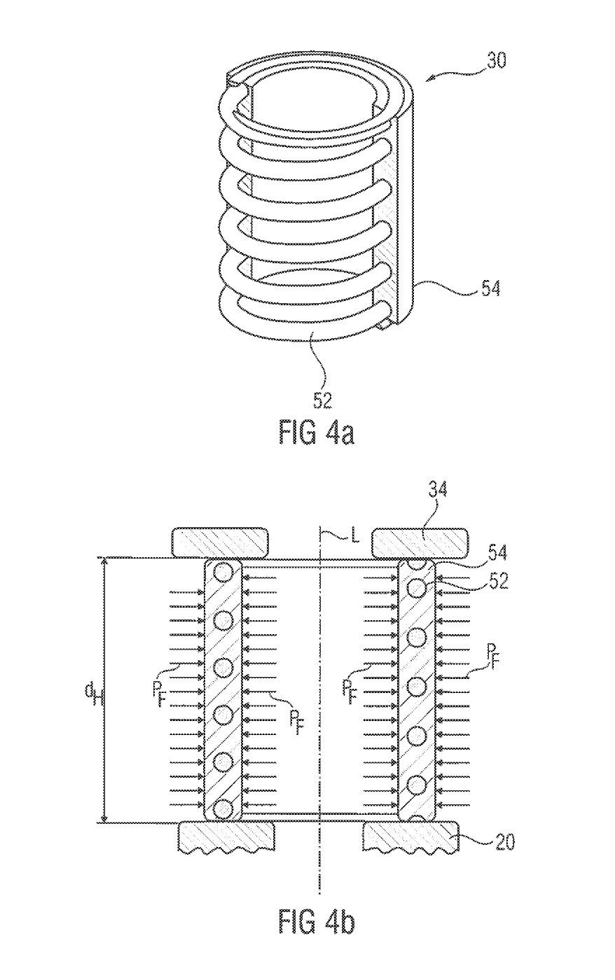

FIG. 4a shows a perspective view of the coil spring with the elastically deformable material 54 being partially cut away for better representation. FIG. 4b shows a cross-sectional view of the coil spring with the elastically deformable material 54.

The spring element 30 may expediently be dimensioned such that it is compressed when the distance d_{H} between the spring seat 34 of the valve needle 22 and the spring seat of the valve body 20 is maximal, i.e. when the valve needle 22 is in the closing position in the present embodiment.

The elastically deformable material 54 may comprise rubber or consist of rubber. Alternatively or additionally, the elastically deformable material 54 may comprise a plastic. As the fuel pressure increases, the elastically deformable material 54 arranged between the spring turns 52 becomes stiffer. Also, by means of this arrangement, it can be achieved that the spring stiffness increases as the fuel pressure increases, which has the effect that the needle is retained in its closing position by a greater force when the fuel pressure increases. The arrows indicate the direction of the fuel pressure.

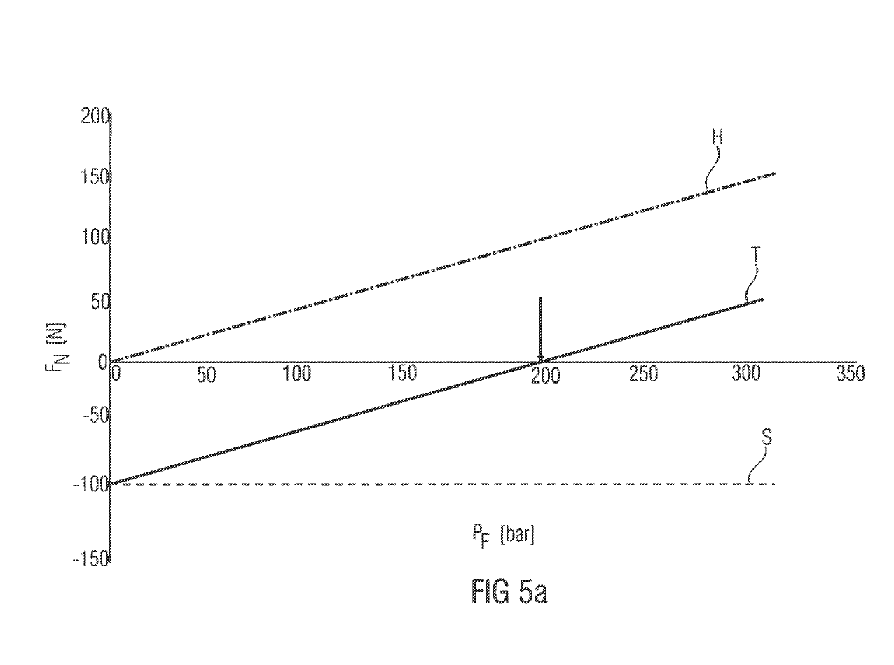

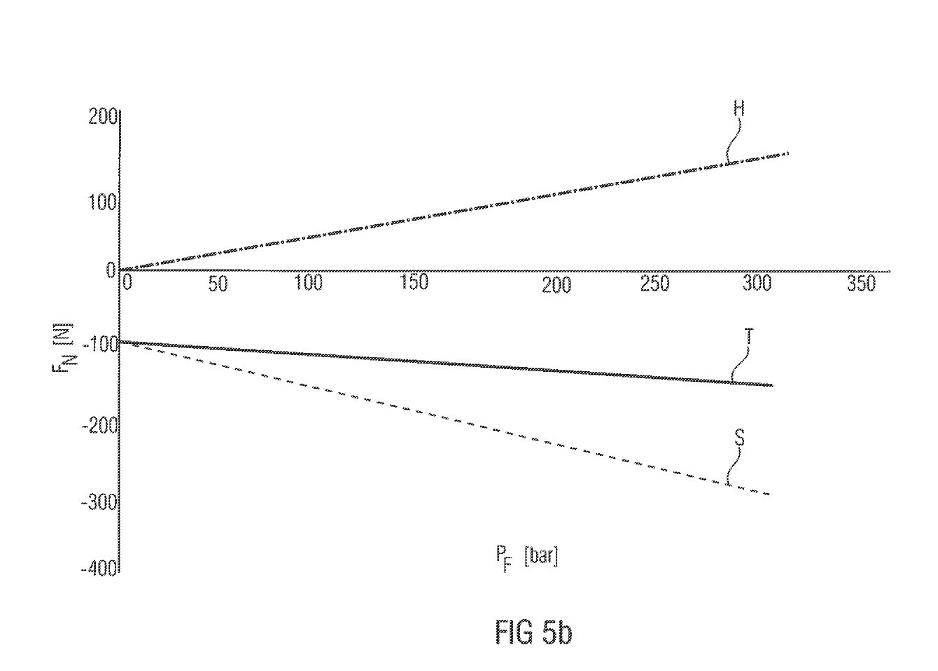

FIGS. 5a and 5b show the load distributions of the valve needle 22 of a conventional valve (FIG. 5a) and of the fluid injection valves according to the above embodiments (FIG. 5b). The forces F_{N} in Newton (N) acting on the valve needle 22 are shown as function of the fuel pressure p_{F} in bar in these figures. Forces F_{N} with positive sign tend to force the valve needle 22 away from the closing position. Forces F_{N} with negative sign bias the valve needle towards the closing position. The absolute force and pressure values are only to be understood as being exemplary and may be varied according to the requirements of the fluid injection valve.

The dotted line represents a hydraulic load H on the valve needle 22 generated by the pressurized fluid in the recess 44 and in the cavity 24. The dashed line represents the spring load S of a spring element 30 biasing the valve needle 22 towards the closing position. The solid line represents a total needle load T of the valve needle 22 resulting from adding the hydraulic load H and the spring load S.

In FIG. 5a the spring element 30 of the conventional injection valve has a constant spring stiffness.

When the solid line, which represents the total needle load T, crosses the x-axis representing the fuel pressure p_{F}, the injector valve opens without coil activation (see the position marked by the arrow pointing downward in FIG. 5a). This is an uncontrollable operating condition.

In FIG. 5b the spring element 30 of the fluid injection valves 10 according to the above embodiments comprises a variable spring stiffness. The spring stiffness increases with increasing fluid pressure p_{F}. The increase in spring stiffness is configured such that it compensates or overcompensates the increase of the hydraulic load H with the fluid pressure p_{F}. In this case, the solid line, which represents the total needle load T, at no point crosses the x-axis. The injector valve does not open without coil activation. When the spring stiffness increase compensates the hydraulic load increase, the spring load S of the spring element 30 and the hydraulic load H have the same gradient. The total needle load T is independent of the fuel pressure p_{F} in this case. In case that the gradients are different, i.e. in the case of an overcompensation of the hydraulic load increase, the pressure range of the fluid injection valve's operating pressure may be further increased.

What is claimed is:

1. A fluid injection valve, comprising:
a fluid inlet tube with a recess,
a valve body having a central longitudinal axis and a cavity with a fluid outlet portion,
a valve needle received in the recess of the fluid inlet tube and in the cavity of the valve body, the valve needle being axially displaceable with respect to the fluid inlet tube and the valve body between a closing position that prevents a fluid flow through the fluid outlet portion and other positions that allow the fluid flow through the fluid outlet portion, and
a spring element arranged in the recess and arranged to interact with the valve needle to bias the valve needle in an axial direction towards the closing position,
wherein a spring stiffness of the spring element depends on a pressure of fluid in the recess.

2. The fluid injection valve of claim 1, wherein:
the valve needle comprises a spring rest, and
the spring element is arranged between the valve body and the spring rest of the valve needle.

3. The fluid injection valve of claim 1, wherein:
the spring element comprises an elastically deformable material, and
the spring stiffness of the spring element depends on a pressure of fluid in the recess as a function of the elastically deformable material interacting with the fluid.

4. The fluid injection valve of claim 3, wherein:
the spring element comprises a coil spring with a defined number of spring turns, and
the elastically deformable material is arranged along at least part of an axial extension of the coil spring between the respective spring turns.

5. The fluid injection valve of claim 1, wherein the spring element comprises an elastic ring-shaped tube.

6. The fluid injection valve of claim 5, wherein the tube is hollow and has an interior that is sealed with respect to the recess.

7. The fluid injection valve of claim 6, wherein the interior is filled with a gas or another fluid.

8. The fluid injection valve of claim 1, wherein the valve is configured to open in a flow direction of the fluid at the fluid outlet portion and the spring element biases the valve needle in a longitudinal direction opposite to said flow direction.

9. An internal combustion engine, comprising
a plurality of fluid injection valves, each fluid injection valve comprising:
a fluid inlet tube with a recess,
a valve body having a central longitudinal axis and a cavity with a fluid outlet portion,
a valve needle received in the recess of the fluid inlet tube and in the cavity of the valve body, the valve needle being axially displaceable with respect to the fluid inlet tube and the valve body between a closing position that prevents a fluid flow through the fluid outlet portion and other positions that allow the fluid flow through the fluid outlet portion, and
a spring element arranged in the recess and arranged to interact with the valve needle to bias the valve needle in an axial direction towards the closing position,
wherein a spring stiffness of the spring element depends on a pressure of fluid in the recess.

10. The internal combustion engine of claim 9, wherein:
the valve needle comprises a spring rest, and
the spring element is arranged between the valve body and the spring rest of the valve needle.

11. The internal combustion engine of claim 9, wherein:
the spring element comprises an elastically deformable material, and
the spring stiffness of the spring element depends on a pressure of fluid in the recess as a function of the elastically deformable material interacting with the fluid.

12. The internal combustion engine of claim 11, wherein:
the spring element comprises a coil spring with a defined number of spring turns, and
the elastically deformable material is arranged along at least part of an axial extension of the coil spring between the respective spring turns.

13. The internal combustion engine of claim 9, wherein the spring element comprises an elastic ring-shaped tube.

14. The internal combustion engine of claim 13, wherein the tube is hollow and has an interior that is sealed with respect to the recess.

15. The internal combustion engine of claim 14, wherein the interior is filled with a gas or another fluid.

16. The internal combustion engine of claim 9, wherein the valve is configured to open in a flow direction of the fluid at the fluid outlet portion and the spring element biases the valve needle in a longitudinal direction opposite to said flow direction.
